(19) United States
(12) Patent Application Publication
(10) Pub. No.: US 2010/0012241 A1
(43) Pub. Date: Jan. 21, 2010

(54) CUSHION GUM

(76) Inventors: Xiaofeng Shaw Yang, Mauldin, SC (US); Brian R. Bergman, Clermont-Ferrand (FR)

Correspondence Address: MICHELIN NORTH AMERICA, INC.;INTELLECTUAL PROPERTY DEPARTMENT, MARC BLDG 31-2, 515 MICHELIN ROAD, GREENVILLE, SC, 29605, US

(21) Appl. No.: 12/518,436

(22) PCT Filed: Dec. 14, 2007
(86) PCT No.: PCT/US07/87505

§ 371 Date: Jun. 10, 2009

(30) Foreign Application Priority Data
Dec. 20, 2006 (US) PCT/US2006/048530

(51) Int. Cl. B60C 1/00; C08L 7/00; C08L 9/00; C08K 3/22; B29D 30/08; B29C 73/00; B29D 30/56

(52) U.S. Cl. 152/151; 525/360; 524/571; 525/370; 525/366; 524/430; 524/433; 524/432; 524/431; 156/128.6; 156/97

(57) ABSTRACT

A cushion gum for bonding a tire tread to a tire carcass, the cushion gum comprising an essentially unsaturated diene elastomer, between (0.5) and (25) phr of a metal salt of a carboxylic acid and a peroxide curing system. The essentially unsaturated diene elastomer may be, in some embodiments, a highly unsaturated diene elastomer such as, for example, natural rubber.

### BACKGROUND OF THE INVENTION

1. Field of the Invention

This invention relates generally to rubber compositions and more specifically, to rubber compositions and methods of their use as cushion gums.

2. Description of the Related Art

The market for retreaded pneumatic tires is almost entirely in the arena of trucking, aircraft, and earthmoving vehicles. In the trucking market, the carcass of a tire is expected to last much longer than the original tread and be amenable to having a new tread adhered to it several times. New truck tires are typically bought with the expectation that their high initial costs are offset by the long service life of the carcass, and the low comparative cost of retreading.

A variety of procedures and different types of equipment are available for use in recapping or retreading pneumatic tires. One of the first steps in retreading a worn tire is to remove remaining tread material from the tire carcass, for example, by a sanding procedure known as buffing. Next a layer of green (uncured) rubber, the cushion gum, is applied to the carcass. This layer of extruded uncured rubber may be stitched or adhesively bonded to the carcass. Next, a tread layer is applied atop the layer of cushion gum. In the cold recapping process, the tread is cured rubber, and has a tread pattern already impressed in its outer surface. The tire is then placed in an autoclave, and heated under pressure for an appropriate time to induce curing of the cushion gum layer, and bonding of the cushion gum layer to the tread and the carcass. In the hot recapping process, the tread is uncured rubber, and has no tread pattern. The tire is then placed in a tire mold and heated under pressure for an appropriate time to cure the gum layer and the tread, and to cause the gum layer to bind with the tread and the carcass. The term “cure” refers to the formation of cross-links between the elastomer molecules in the rubber compound, otherwise known as vulcanization.

Rubber elastomers are often cured using either a sulfur curing system or a free radical cure system. Of the free radical curing systems, the systems that utilize organic peroxides as the free radical generator are the most common and well known. Peroxide curing systems initiate crosslinking via free radical mechanisms using the organic peroxide as the curing agent. Known advantages of peroxide curing systems include, for example, the ability to cause crosslinking in lower compression set, better chemical and oil resistance, less discoloration, and better color stability with less staining.

Coagents have been used in peroxide curing systems in order to ameliorate the disadvantages while capitalizing on the desirable characteristics of free radical curing systems. U.S. Pat. No. 5,310,811 discloses the use of a free radical curing system and compares the effect of coagents on the cured elastomers. The coagents studied included trimethylol propane trimethacrylate, zinc dimethacrylate (ZDMA) and hydroquinone dimethacrylate. The effects of these coagents added separately to elastomer compositions were studied.

U.S. Pat. No. 5,506,308 discloses the use of a peroxide curing system that uses a precure inhibitor as well as zinc dimethacrylate (ZDMA). The precure inhibitor protects against scorch or prevulcanization of the elastomer and the unsaturated carboxylic metal salt during compounding.

### SUMMARY OF THE INVENTION

Embodiments of the present invention include a cushion gum for bonding a tire tread to a tire carcass, the cushion gum comprising an essentially unsaturated diene elastomer, between 0.5 and 25 phr of a metal salt of a carboxylic acid and a peroxide curing system. The essentially unsaturated diene elastomer may be, in some embodiments, a highly unsaturated diene elastomer such as, for example, natural rubber.

The metal salt of a carboxylic acid may be, for example, zinc dimethacrylate, zinc diacrylate, magnesium dimethacrylate, and magnesium diacrylate either alone or in combination. Particular embodiments may further include a metal oxide such as, for example, magnesium oxide, zinc oxide or combinations thereof.

Methods for bonding a tread to a tire are also embodiment of the invention. One such embodiment includes applying a cushion gum to a bonding surface of a tread band, to an outer bonding surface of a tire carcass or combinations thereof; placing the bonding surface of the tread band onto the outer bonding surface of the tire carcass with the cushion gum therebetween, wherein the cushion gum comprises an embodiment of the cushion gum disclosed herein. Other embodiments include, for example, a tire having a tread bonded onto a tire carcass with an embodiment of the cushion gum disclosed herein.

The foregoing and other objects, features and advantages of the invention will be apparent from the following more detailed descriptions of particular embodiments of the invention.

### DETAILED DESCRIPTION OF PARTICULAR EMBODIMENTS

The present invention provides a cushion gum and articles utilizing the cushion gum as well as methods for using the cushion gum. The cushion gum is a rubber composition that is cured or is curable using a free-radical curing system such as a peroxide curing system and that may further include a metal salt of a carboxylic acid and/or a metal oxide curing agent. The cushion gum provides a material having significantly improved physical properties over cushion gums cured with a sulfur curing system. Therefore, particular embodiments of the present invention do not include a cushion gum cured with a sulfur curing system. The cured cushion gum according to the present invention is based upon the uncured cushion gum composition of the present invention; i.e., the cushion gum includes the uncured cushion gum and the cured cushion gum obtained by curing the uncured cushion gum.

The cushion gum of particular embodiments of the present invention includes an essentially unsaturated diene elastomer. A “diene” elastomer or rubber is understood to mean, generally, an elastomer resulting at least in part (i.e. a homopolymer or a copolymer) from diene monomers having two double carbon-carbon bonds, whether conjugated or not. An “essentially unsaturated” diene elastomer is understood to mean a diene elastomer resulting at least in part from conjugated diene monomers and having a content of units of conjugated diene origin that is greater than 15 mol. %. A “highly unsaturated” diene elastomer falls within the category of an essentially unsaturated diene elastomer but is understood to mean a diene elastomer having a content of units of conjugated diene origin that is greater than 50 mol. %.

An “essentially saturated” diene elastomer is understood to mean a diene elastomer having a low or very low content of units of diene origin, which is always less than 15%. Thus, for example, an elastomer such as a butyl rubber, a copolymer of a diene and of an alpha-olefin of the ethylene-propylene diene terpolymer (EPDM) type or a copolymer of an ethylene-vinyl acetate type do not fall within the definition of an essentially unsaturated diene elastomer. Particular embodiments of a cushion gum in accordance with the present invention include 0 wt. % of an essentially saturated diene elastomer. Other embodiments may optionally include a low quantity of an essentially saturated diene elastomer such embodiments including, for example, less than 1, 3 or 5 wt. % of the total elastomer content, less than 6, 8 or 10 wt. %, less than 12 or 15 wt. % or less than 17, 20, 22 or 25 wt. % of the total elastomer content.

As known by one having ordinary skill in the art, a highly unsaturated diene elastomer may, for example, be obtained from:

(a)—any homopolymer obtained by polymerisation of a conjugated diene monomer having between 4 and 12 carbon atoms;

(b)—any copolymer obtained by copolymerization of a conjugated diene with each other or with a vinyl-aromatic compound having between 8 and 20 carbon atoms.

Suitable conjugated dienes include, for example, 1,3-butadiene, 2-methyl-1,3-butadiene, 2,3-di(C₁-C₅ alkyl)-1,3-butadienes such as 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Suitable vinyl-aromatic compounds include, for example, styrene, ortho-, meta- and para-methylstyrene, the commercial mixture “vinyltoluene”, para-tert.-butylstyrene, methoxystyrenes, chlorostyrenes, vinylmesitylene, divinylbenzene and vinylnaphthalene.

The copolymers may contain between 99% and 20% by weight of diene units and between 1% and 80% by weight of vinyl-aromatic units. The elastomers may have any microstructure, which is a function of the polymerisation conditions used, in particular of the presence or absence of a modifying and/or randomising agent and the quantities of modifying and/or randomising agent used. The elastomers may for example be block, statistical, sequential or microsequential elastomers, and may be prepared in dispersion or in solution; they may be coupled and/or starred or alternatively functionalised with a coupling and/or starring or functionalising agent.

The rubber elastomers that are useful for particular embodiments of the present invention include natural rubber, essentially unsaturated synthetic rubber or combinations thereof that are curable with a metal salt of a carboxylic acid and a peroxide cure system or other free radical initiator curing system.

In particular embodiments of the cushion gum, the diene elastomer of the composition is highly unsaturated and may be selected, for example, from a polybutadiene (BR), a synthetic polyisoprene (IR), a natural rubber (NR), a butadiene copolymer, an isoprene copolymer, a styrene-butadiene copolymer (SBR), a butadiene-isoprene copolymer (BIR), an styrene-isoprene copolymer (SIR), a styrene-butadiene-isoprene copolymer (SBIR) and mixtures thereof. Particular embodiments of the cushion gun include only natural rubber as the highly unsaturated diene elastomer.

The cushion gum may include an essentially unsaturated diene rubber that is a highly unsaturated synthetic rubber such as polybutadiene rubber, styrene-butadiene rubber, polyisoprene rubber, copolymers thereof and combinations thereof.

As noted above, particular embodiments of the cushion gum according to the present invention may be characterized as being curable or as being cured by a peroxide curing system. A peroxide curing system may include an organic peroxide as a peroxide curing agent, examples of which may include di-cumyl peroxide; tert-butyl cumyl peroxide; 2,5-dimethyl-2,5 bis(tert-butyl peroxy)hexyne-3; bis(tert-butyl peroxy isopropyl)benzene; n-butyl 4,4′-di(tert-butyl peroxy)valerate; 1,1-di-tert-butylperoxy-3,3,5-trimethylcyclohexane; bis-(tert-butyl peroxy)-diisopropyl benzene; t-butyl perbenzoate; di-tert-butyl peroxide; 2,5-dimethyl-2,5-di-tert-butylperoxide hexane and combinations thereof.

The amount of peroxide curing agent useful in particular embodiments of a cushion gum depends, as known to one having ordinary skill in the art, upon the elastomer and coagent loading utilized. In general, such amounts of peroxide curing agent may be between about 0.1 pounds per hundred weight of elastomer (phr) and about 10 phr. Particular embodiments may utilize the peroxide at between about 0.1 phr and about 5 phr or alternatively, between about 0.5 and about 3.5 phr.

Other free radical generating compounds and mechanisms may also be employed in particular embodiments in lieu of the organic peroxide. Examples of such include ultra-violet light, beta and gamma radiation, azo compounds such as 2′,2′-azobisisobutyronitrile, 2,2′-azobis(2,4-dimethylpentanenitrile), 1,1′-azobis(cyclohexane-carbonitrile), disulfides and tetrazenes. These compounds and mechanisms as well as their use as rubber elastomer curative systems are well known to those having ordinary skill in the art.

The cushion gum according to particular embodiments of the present invention may further include a curing coagent that is a metal salt of a carboxylic acid and/or a metal oxide. Examples of a suitable metal oxide include, for example, zinc oxide, magnesium oxide and combinations thereof. The metal portion of useful metal oxides may include, for example, sodium, potassium, iron, magnesium, calcium, zinc, barium, aluminum, tin, zirconium, lithium, cadmium and cobalt. Each metal oxide curing coagent may be used alone or in combination with other metal oxide curing coagents.

A suitable metal salt of a carboxylic acid may include particularly a metal salt of an unsaturated carboxylic acid. Examples of a suitable salt include zinc dimethacrylate (ZDMA), zinc diacrylate (ZDA), magnesium dimethacrylate, magnesium diacrylate or combinations thereof. Other useful salts used alone or in combination with others may include, for example, a zinc monomethacrylate (ZMMA) or a zinc monoacrylate. Other suitable acrylates as known to those having ordinary skill in the art may be used alone or in combination with other acrylates, including a methacrylate.

More generally, a useful metal salt for inclusion in particular embodiments of the cushion gum may be made from carboxylic acids such as methacrylic acid, ethacrylic acid, acrylic acid, cinnamic acid, crotonic acid, maleic acid, fumaric acid, itaconic acid, and combinations thereof.

The metal used to form the useful metal salt with the carboxylic acid may include, for example, sodium, potassium, iron, magnesium, calcium, zinc, barium, aluminum, tin, zirconium, lithium, cadmium, cobalt and combinations thereof. Oxides of these metals may also be used alone and/or in combination with other coagents.

Particular embodiments of the cushion gum according to the present invention may include the use of the metal salt and/or oxide each in an amount between about 0.5 phr and 50 phr. In other embodiments, the metal salt and/or oxide may each be included in an amount between about 0.5 and 25 phr, between about 0.5 and about 12 phr, between about 0.5 and about 8 phr, between about 0.5 and about 5 phr or between about 2.5 and about 6 phr.

Particular embodiments of the present invention may further include a multifunctional curing coagent that is included in the curable elastomer composition. Particular embodiments of the present invention include as the multifunctional curing coagent a bifunctional curing coagent. Particular embodiments of the present invention include an amount of the multifunctional curing coagent at quantities between 0.1 and 10 phr or alternatively, between 0.25 and 7 phr. Particular embodiments of the present invention further include an amount of the multifunctional curing coagent of between 0.25 and 5 phr.

The multifunctional curing coagents useful in the present invention include any of the multifunctional curing coagents that, when combined in curable elastomer compositions in effective amounts with a metal salt of a carboxylic acid and a free radical curing system, provide an improved hysteresis at temperatures above 120° C. of the cured elastomers. Examples of multifunctional curing agents include maleimides, acrylates, cyanurates, anhydrides and combinations thereof. Examples of anhydrides include maleic anhydride, succinic anhydride and combinations thereof.

Examples of maleimides include n,n′-m-phenylene dimaleimide and 1,3-Bis(citraconimidomethyl)benzene. Examples of mono-acrylates include octyl/decyl acrylate, 3-chloro-2-hydroxypropyl methacryulate, oligoester acrylate(s) and combinations thereof.

Examples of di-acrylates include 1,6-hexanediol diacrylate, diethylene glycol diacrylate, diethylene glycol dimethacrylate, 1,6-hexanediol dimethylacrylate, 1,6-hexanediol diacrylate, polybutadiene diacrylate, 1,3, butylene dimethacrylate, 1,4, butylene dimethacrylate, polyethylene glycol dimethacrylate, 1,4 butanediol diacrylate, 2,2′bis(4-methacryloxydiethoxyphenyl) propane, 2,2′bis(4-acryloxydiethoxyphenyl) propane, 1,4 benzene diacrylate, 1,4 benzene dimethacrylate, 1,3.benzene diacrylate, 1,3.benzene dimethacrylate, 1,4.benzene diacrylate, 1,4-benzene dimethacrylate, 1,2.benzene diacrylate, 1,2.benzene dimethacrylate, 1,2-naphthalene diacrylate, 1,2-naphthalene dimethacrylate, 1,3-naphthalene diacrylate, 1,3-naphthalene dimethacrylate, 1,4-naphthalene diacrylate, 1,4-naphthalene dimethacrylate, 1,5-naphthalene diacrylate, 1,5-naphthalene dimethacrylate, 1,6-naphthalene diacrylate, 1,6-naphthalene dimethacrylate, 1,7-naphthalene diacrylate, 1,7-naphthalene dimethacrylate, 1,8-naphthalene diacrylate, 1,8-naphthalene dimethacrylate, 2,3-naphthalene diacrylate, 2,3-naphthalene dimethacrylate, 2,6-naphthalene diacrylate, 2,6.naphthalene dimethacrylate, 2,7-naphthalene diacrylate, 2,7-naphthalene dimethacrylate, and combinations thereof.

Examples of tri-acrylates include trimethylolpropane triacrylate, trimethylolpropane trimethacrylate, trimethylolpropane triacrylate, pentaerythritol triacrylate, 1,3,5-benzene triacrylate, 1,3,5-benzene trimethacrylate, 1,2,3-benzene triacrylate, 1,2,3-benzene trimethacrylate, 1,2,4-benzene triacrylate, 1,2,4-benzene trimethacrylate, 1-hydroxybenzene-3,5-diacrylate, 1-hydroxybenzene 3,5-dimethacrylate, 1hydroxybenzene-2,3-diacrylate, 1-hydroxybenzene-2,3-dimethacrylate, 1-hydroxybenzene-2,4-diacrylate, 1-hydroxybenzene 2,4-dimethacrylate, 1,3,5naphthalene triacrylate and its isomers, 1,3,5-naphthalene trimethacrylate and its isomers, 1-hydroxy naphthalene-3,5-diacrylate and its isomers, 1-hydroxy naphthalene-3,5-dimethacrylate and its isomers and combinations thereof.

Other useful multifunctional curing agents include tetra-acrylates such as pentaerythritol tetraacrylate; penta-acrylates such as dipentanerythritol pentaacrylate; and cyanurates such as trially cyanurate and trially isocyanurate.

Particular embodiments of the present include multifunctional curing coagents such as, for example, 1,3-Bis(citraconimidomethyl)benzene (known as DP900 and available as PERKALINK 900 from Flexsys, Inc. of Akron, Ohio), N,N′-m-phenylenedimaleimide (Bis-maleimide), BMI (1,2-phenylene dimaleimide), BMI (1,4-phenylene dimaleimide) and combinations thereof maleic anhydride, succinic anhydride and acrylate esters. An example of a suitable acrylate ester is a blend of multifunctional acrylate esters available as SR354, a product of Sartomer Company, Inc. of Pennsylvania.

Particular embodiments of a cushion gum in accordance with the present invention may further include reinforcement fillers such as carbon black, so-called white or inorganic fillers or combinations thereof. The white or inorganic filler used as reinforcing filler may constitute all or only part of the total reinforcing filler, in this latter case associated, for example, with carbon black.

In the present application, “reinforcing inorganic filler”, in known manner, is understood to mean an inorganic or mineral filler, whatever its color and its origin (natural or synthetic), also referred to as “white” filler or sometimes “clear” filler in contrast to carbon black. This inorganic filler is capable, on its own, without any means other than an intermediate coupling agent, of reinforcing a rubber composition intended for the manufacture of tires; i.e., is capable of replacing all or at least a portion of conventional tire-grade carbon black filler in its reinforcement function.

The reinforcing inorganic filler may be a mineral filler of the siliceous or aluminous type, or a mixture of these two types of fillers. The physical state in which the reinforcing inorganic filler is present may be, for example, without limiting the invention, in the form of a powder, micro-beads, granules, balls or combinations thereof. Of course, “reinforcing inorganic filler” is also understood to mean mixtures of different reinforcing inorganic fillers, in particular of highly dispersible siliceous and/or aluminous fillers.

As noted above, carbon black may be used alone or in combination with the inorganic fillers. Any carbon black is useful for the rubber compositions of the present invention as long as it is suitable for the particular application. Suitable carbon blacks that may be used in particular embodiments of the present invention include the blacks of the type HAF, ISAF and SAF, which are conventionally used in tires, and particularly in treads for these tires. As non-limitative examples of such blacks, mention may be made of the blacks N115, N134, N234, N339, N347, N375, and the 600 series, including, but not limited to, N630, N650 and N660. The amount of carbon black present in the total reinforcing filler may vary within wide limits, e.g., between 5 and 100 phr or between 20 and 80 phr or between 30 and 70 phr. Alternatively, as well known in the art, the carbon black may be added to the rubber composition without the addition of an inorganic reinforcing filler.

In addition to the rubber elastomer and reinforcement filler, particular embodiments of the rubber composition may further include all or part of the additives that may typically be used in rubber compositions intended for use as cushion gum, repair filling material, rubber-based adhesive or other rubber-containing articles. Such additives may include, for example, plasticizers, extender oils, pigments, protective agents that include antioxidants. There may also be associated with the reinforcing inorganic filler, if necessary, a conventional non-reinforcing white filler, such as for example particles of clay, bentonite, talc, chalk, kaolin or titanium oxides.

Particular embodiments of the rubber composition may include a plasticizing oil that is synthetic and/or extracted from petroleum. The plasticizing oil may be, for example, a paraffinic, aromatic or naphthenic type although it is thought that a plasticizing oil of low aromatic content may minimize interference with peroxide crosslink formulation. Therefore, particular embodiments of the cushion gum may include a plasticizing oil of low aromatic content, i.e., less than 50 mol. %. Embodiments of the cushion gum may include the plasticizing oil in an amount of between 1 phr and 60 phr or alternatively between 1 phr and 35 phr or between 5 and 30 phr or between 5 and 20 phr or between 5 and 15 phr or between 5 and 10 phr.

In particular embodiments, a plasticizing resin may be included in the cushion gum composition to replace some or all of the plasticizing oil. A plasticizing hydrocarbon resin is a hydrocarbon compound that is solid at ambient temperature (e.g., 23° C.) as opposed to a liquid plasticizing compound, such as a plasticizing oil. Additionally a plasticizing hydrocarbon resin is compatible, i.e., miscible, with the rubber composition with which the resin is mixed at a concentration that allows the resin to act as a true thinning agent, e.g., at a concentration that is typically at least 5 phr (parts per hundred parts rubber by weight).

Plasticizing hydrocarbon resins are polymers that can be aliphatic, aromatic or combinations of these types, meaning that the polymeric base of the resin may be formed from aliphatic and/or aromatic monomers. These resins can be natural or synthetic materials and can be petroleum based or not, in which case the resins may be called petroleum plasticizing resins. In particular embodiments, although not limiting the invention, these resins may contain essentially only hydrogen and carbon atoms.

The cushion gum of particular embodiments of the present invention may further include an antidegradant. Suitable antidegradants include, for example, polymerized 1,2-dihydro-2,2,4-trimethylquinoline (TMQ), tetrakis(methylene (3,5-di-t-butyl-4-hydroxyhy-drocinnamate)) methane and zinc 2-mercaptotoluimidazole.

Particular embodiments of the cushion gum are useful for repairing tires. A tire or other article comprising an elastomer surface may be repaired by filling a hole, cut, gash, gouge or other opening in the article with a repair filling product based on the cushion gum disclosed herein. Particular embodiments of the cushion gum may also be used as a rubber-based adhesive to bond a patch to the interior of a tire for a tire repair or to other rubber articles. Passenger tires, truck tires, motorcycle tires, off-road tires and other types of tires may be repaired or patched using the embodiments of the cushion gum as disclosed herein.

Particular embodiments of the present invention therefore include tires or other articles having elastomeric surfaces to be bonded and/or repaired with the cushion gum. In the case of a tire having a cut, crack, hole or gouge, the area to be repaired is typically prepared by removing loose surface material and cleaning the surface within and around the damaged area. Preparation may include buffing the surface inside the gouge, cut or crack via any conventional apparatus or treatment. The cushion gum may be used as a repair filling product to fill the cut, crack, hole or gouge that may appear, for example, in a tire sidewall. Likewise, the cushion gum may be used as a rubber-based adhesive to bond a patch to a repair area of the tire. Embodiments of the cushion gum may be applied to either the surface on to which the patch is to be applied, onto the surface of the patch itself or combinations thereof. The patch is then stitched into place on the article to be repaired. The cushion gum embodiments used to repair or patch the tire are then cured with the tire or other article in a known manner.

The invention is further illustrated by the following exemplary examples, which are not to be regarded as being delimitative of the invention in any way. The properties of the compositions disclosed in the examples were evaluated as described below.

Moduli of elongation were measured at 10%, 100% and at 300% at a temperature of 23° C. in accordance with ASTM Standard D412 on ASTM C test pieces. These measurements are true secant moduli in MPa, that is to say the secant moduli calculated reduced to the real cross-section of the test piece at the given elongation.

Hysteresis losses (HL) were measured in percent by rebound at 60° C. at the sixth impact in accordance with the following equation:

HL(%)=100(W₀−W₁)/W₁,

where W₀ is the energy supplied and W₁ is the energy restored.

The elongation property was measured as elongation at break (%) and the corresponding elongation stress (MPa), which is measured at 23° C. in accordance with ASTM Standard D412 on ASTM C test pieces.

Tear strength was determined from test samples cut from a cured plaque with a thickness of approximately 2.5 mm. Notches (perpendicular to the test direction) were created in the samples prior to testing. The force and elongation at break was measured using an Instron 5565 Uniaxial Testing System. The cross-head speed was 500 mm/min. Samples were tested at ambient and at 60° C. and at 100° C. The tear strength index was defined as the product of the force at rupture (MPa)* the elongation at break (%) divided by 100. The higher the index for a material, the less susceptible is the material to tearing.

Cyclic fatigue testing was conducted on the cured test samples that were dumbbell shaped and 65 mm long. The test was conducted at ambient temperature by imposing cyclic strain from between 0% and 75% on the test pieces. The total number of cycles to failure was recorded for each test sample as the measurement of cyclic fatigue.

Mooney Plasticity (ML 1+4): Mooney Plasticity is measured in accordance with ASTM Standard D1646-04. In general, the composition in an uncured state is molded in a cylindrical enclosure and heated to 100° C. After 1 minute of preheating, the rotor turns within the test sample at 2 rpm, and the torque used for maintaining this movement is measured after 4 minutes of rotation. The Mooney Plasticity is expressed in “Mooney units” (MU, with 1 MU=0.83 Newton-meter).

### Example 1

Several batches of cushion gum were prepared with the materials shown in Table 1. Two thermochemical stages were used to prepare the rubber compositions. First, the elastomer, the carbon black and all the other ingredients except for the oil and vulcanization agents were introduced into an eight liter Banbury-type mixer in the amounts shown in Table 1. This material was then mixed at a rotor speed of 55 RPM, After the temperature in the mixer reached 80° C., the oil was added to the mixer. The mixing was continued until the temperature reached 145° C. at which time the mixture was dropped and allowed to cool to about 50° C.

TABLE 1
Compositions of Cushion Gum Examples, phr

| | W | A | B | C | D | E | F | G | H | I | J |
|---|---|---|---|---|---|---|---|---|---|---|---|
| Elastomer (NR) | 100 | 100 | 100 | 100 | 100 | 100 | 100 | 100 | 100 | 100 | 100 |
| Plasticizer Oil 1 | 25 | | | | | | | | | | |
| Plasticizer Oil 2 | | 21.6 | 21.6 | 21.6 | 21.6 | 16.6 | 21.6 | 21.6 | 21.6 | 18.6 | 18.6 |
| Carbon Blk (N347) | 45 | 45 | 45 | 45 | 45 | 45 | 45 | 45 | 45 | 45 | 45 |
| Tackifier resin | 3 | 3 | 3 | 3 | 3 | 3 | 3 | 3 | 3 | 3 | 3 |
| ZDMA | | | | | 5.0 | 5.0 | | | | 3.0 | 5.0 |
| Additives | 3.0 | | | | | | | | | | |
| Zinc Oxide | 5.0 | | | | | | 5.0 | | | | 1.0 |
| TMQ | | | | | | | | | | | 1.0 |
| Peroxide TBTC | | 1.2 | 2.4 | 3.2 | 1.2 | 3.2 | 3.2 | | 2.2 | 2.0 | 2.4 |
| Peroxide TBV | | | | | | | | 2.4 | | | |
| Sulfur Curing System | 6.9 | | | | | | | | | | |

In the second stage, the cooled mixture was transferred to a mill having two cylinders that operated at a speed of 30 RPM. The vulcanizing agents were added and mixing continued until the vulcanizing agents were well dispersed, which was for up to about 8 minutes milling time.

The carbon black was N347. The tackifier was SYLVARES TR-5147, a polylimonene resin available from Arizona Chemical, Savannah, Ga. The oil was naphthenic for the cushion gum examples and aromatic for the witness. The sulfur curing system included insoluble sulfur, accelerators and vulcanization actuators as known to one having ordinary skill in the art. The additive package included antioxidants.

The 1,1′-di(tert-butylperoxy)-3,3,5-trimethylcyclohexane (TBTC) was added as the product VAROX 231XL40, which includes 40 wt. % active peroxide. The n-butyl-4-4′-di(tert-butylperoxy) valerate (TBV) was added as the product VAROX 230XL40, which includes 40 wt. % active peroxide. The amount (phr) of peroxide shown in Table 1 includes only the active peroxide portion of the product added.

The cushion gum compositions were rolled into sheets and cured for the time period shown in Table 2 at a temperature of 125° C. for the witness and for samples H, I and J and at a temperature of 150° C. for all the other compositions shown in Table 1. The cured sheets were then cut into testing pieces suitable for the testing methods utilized to determine the physical characteristics of the cushion gum examples.

### Example 2

The physical properties of the cushion gum compositions produced in Example 1 were tested for their physical properties according to the methods described above. The physical properties of the cushion gum compositions are shown in Table 2. The Witness composition is identified as “W” in Tables 1 and 2.

TABLE 2
Physical Properties of Cushion Gum Examples

| | W | A | B | C | D | E | F | G | H | I | J |
|---|---|---|---|---|---|---|---|---|---|---|---|
| Curing Temperature, ° C. | 125 | 150 | 150 | 150 | 150 | 150 | 150 | 150 | 125 | 125 | 125 |
| Curing Minutes | 40 | 25 | 25 | 25 | 25 | 25 | 25 | 25 | 180 | 180 | 180 |
| Modulus 10% @ 23° C. (MPa) | 2.98 | 1.36 | 2.15 | 2.61 | 1.52 | 3.19 | 2.63 | 1.98 | 2.40 | 2.63 | 2.95 |
| Modulus 100% @ 23° C. | 1.51 | 0.71 | 1.50 | 2.12 | 0.79 | 2.50 | 2.05 | 1.33 | 1.65 | 1.66 | 1.88 |
| (MPa) | | | | | | | | | | | |
| Modulus 300% @ 23° C. | 1.56 | 1.14 | 2.55 | | 1.13 | | | 2.09 | 2.65 | 2.37 | 2.58 |
| (MPa) | | | | | | | | | | | |
| Hysteresis Losses @ 60° C. | 16.4 | 22.5 | 12.7 | 9.0 | 27.2 | 14.3 | 10.6 | 14.6 | 10.2 | 15.8 | 17.0 |
| (%) | | | | | | | | | | | |
| Tear Load @ 23° C. (N/mm) | 41 | 6 | 16 | 8 | 7 | 11 | 9 | 10 | 13 | 24 | 45 |
| Tear Elongation @ 23° C. (%) | 276 | 92 | 108 | 42 | 94 | 49 | 46 | 75 | 92 | 138 | 199 |
| Tear Index @ 23° C. | 113 | 6 | 18 | 3 | 7 | 6 | 4 | 7 | 12 | 33 | 89 |
| Tear Load @ 100° C. (N/mm) | 22 | 24 | 15 | 8 | 20 | 10 | 10 | 15 | 14 | 18 | 21 |
| Tear Elongation @ 100° C. | 170 | 330 | 115 | 37 | 296 | 43 | 52 | 124 | 102 | 129 | 135 |
| (%) | | | | | | | | | | | |
| Tear Index @ 100° C. | 38 | 80 | 18 | 3 | 60 | 4 | 5 | 18 | 15 | 23 | 28 |
| Elongation Break Stress | 21 | 13 | 17 | 13 | 13 | 14 | 14 | 15 | 12 | 14 | 18 |
| (MPa) | | | | | | | | | | | |
| Elongation Break Strain (%) | 587 | 426 | 324 | 224 | 404 | 222 | 238 | 323 | 254 | 282 | 323 |
| Fatigue Life (K cycles) | 75.1 | | | | | 19.2 | 9.8 | | 13.3 | 28.2 | 65.4 |

### Example 3

Some of the cushion gum compositions that were tested in Example 2 were then aged and tested for their physical characteristics to determine the effect of aging on the cushion gum compositions. The samples were aged by being placed in a non-circulating air oven for seven days at 77° C. The results of the testing are shown in Table 3.

TABLE 3
Physical Properties of Aged Cushion Gum

| | W | H | I | J |
|---|---|---|---|---|
| Modulus 100% @ 23° C. (MPa) | 2.10 | 1.42 | 1.63 | 1.97 |
| Hysteresis Losses @ 60° C. (%) | 18.8 | 12.8 | 18.2 | 18.5 |
| Tear Index @ 100° C. | 20 | 16 | 24 | 24 |
| Fatigue Life (M cycles) | 29.5 | 12.7 | 32.4 | 71.9 |

Percent Change After Aging

| | | | | |
|---|---|---|---|---|
| Modulus 100% @ 23° C. | 39 | −14 | −2 | 5 |
| Hysteresis Losses @ 60° C. | 15 | 25 | 15 | 9 |
| Tear Index @ 100° C. | −48 | 10 | 8 | −12 |
| Fatigue Life | −61 | −4 | 15 | 10 |

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A cushion gum for bonding a tire tread to a tire carcass, the cushion gum comprising:
an essentially unsaturated diene elastomer;
between 0.5 and 25 phr of a metal salt of a carboxylic acid; and
a peroxide curing system.

2. The cushion gum of claim 1, wherein the essentially unsaturated diene rubber is natural rubber.

3. The cushion gum of claim 1, wherein the essentially unsaturated diene rubber is a synthetic rubber selected from polybutadiene rubber, styrene-butadiene rubber, polyisoprene rubber, copolymers thereof or combinations thereof.

4. The cushion gum of claim 1, wherein the peroxide curing system includes a peroxide selected from 1,1′-di(tert-butylperoxy)-3,3,5-trimethylcyclohexane or n-butyl-4-4′-di(tertbutyl-peroxy) valerate.

5. The cushion gum of claim 1, further comprising:
a plasticizing material having a low aromatic content.

6. The cushion gum of claim 1, wherein the metal salt is selected from zinc dimethacrylate, zinc diacrylate or combinations thereof.

7. The cushion gum of claim 1, wherein the metal salt is selected from magnesium dimethacrylate, magnesium diacrylate or combinations thereof.

8. The cushion gum of claim 1, comprising:
between 0.5 and 10 phr of the metal salt of the carboxylic acid.

9. The cushion gum of claim 1, wherein the metal salt of the carboxylic acid is selected from a salt of a metal that is selected from sodium, potassium, iron, magnesium, calcium, zinc, barium, aluminum, tin, zirconium, lithium, cadmium or cobalt.

10. The cushion gum of claim 1, further comprising:
between 0.5 and 25 phr of a metal oxide.

11. The cushion gum of claim 8, wherein the metal oxide is selected from magnesium oxide, zinc oxide or combinations thereof.

12. The cushion gum of claim 8, wherein the metal oxide is selected from an oxide of a metal that is selected from sodium, potassium, iron, magnesium, calcium, zinc, barium, aluminum, tin, zirconium, lithium, cadmium or cobalt.

13. The cushion gum of claim 1, further comprising:
between 0.1 and 10 phr of a multifunctional curing coagent.

14. The cushion gum of claim 13, wherein the multifunctional curing coagent is selected from maleimides, acrylates, cyanurates, anhydrides or combinations thereof.

15. The cushion gum of claim 13, wherein the multifunctional curing coagent is selected from 1,3-Bis(citraconimidomethyl)benzene, N,N′-m-phenylenedimaleimide, BMI (1,2-phenylene dimaleimide), BMI (1,4-phenylene dimaleimide), maleic anhydride, succinic anhydride, acrylate esters or combinations thereof.

16. A method for bonding a tread to a tire, comprising:
applying a cushion gum to a bonding surface of a tread band, to an outer bonding surface of a tire carcass or combinations thereof; and
placing the bonding surface of the tread band onto the outer bonding surface of the tire carcass with the cushion gum therebetween, wherein the cushion gum comprises:
an essentially unsaturated diene elastomer;
between 0.5 and 25 phr of a metal salt of a carboxylic acid; and
a peroxide curing system.

17. The method of claim 16, further comprising:
curing the cushion gum after the step of placing the bonding surface of the tread band onto the outer bonding surface of the tire carcass with the cushion gum therebetween.

18. A tire, comprising:
a tread bonded to a tire carcass by a layer of a cushion gum based upon a cushion gum comprising:
an essentially unsaturated diene elastomer;
between 0.5 and 25 phr of a metal salt of a carboxylic acid; and
a peroxide curing system.

19. The tire of claim 18, wherein the cushion gum further comprises:
between 0.1 and 10 phr of a multifunctional curing coagent, wherein the multifunctional curing coagent is selected from maleimides, acrylates, cyanurates, anhydrides or combinations thereof.

20. A method for repairing a tire, the method comprising:
filling a damaged surface of the tire rubber article with a repair filling material, wherein the damaged surface is an exposed surface of a hole, gash, gouge, split, cut or tear in the article, wherein the repair filling material comprises:
an essentially unsaturated diene elastomer;
between 0.5 and 25 phr of a metal salt of a carboxylic acid; and
a peroxide curing system.

21. The method of claim 20, wherein the article is a tire and wherein the hole, gash, gouge, split, cut or tear is in a sidewall of the tire, an interior surface of the tire and combinations thereof.

22. A cushion gum for bonding a tire tread to a tire carcass, the cushion gum comprising:
an essentially unsaturated diene elastomer;
between 0.5 and 25 phr of a metal salt of a carboxylic acid; and
a free radical initiator curative for the rubber elastomer.
